(19) United States
(12) Patent Application Publication
(10) Pub. No.: US 2015/0126911 A1
(43) Pub. Date: May 7, 2015

(54) SYSTEM FOR PROMOTING ELONGATION AND RELAXATION OF MUSCLES

(71) Applicants: John Abramowicz, Mississauga (CA); Lars Kristjansen, North York (CA)

(72) Inventors: John Abramowicz, Mississauga (CA); Lars Kristjansen, North York (CA)

(21) Appl. No.: 14/529,556

(22) Filed: Oct. 31, 2014

Related U.S. Application Data
(60) Provisional application No. 61/898,629, filed on Nov. 1, 2013.

(51) Int. Cl. A61H 1/00; A61H 1/02

(52) U.S. Cl. CPC A61H 1/00; A61H 1/0218
USPC 601/5

(57) ABSTRACT

A therapeutic apparatus is provided for periodic isotonic stretching of one or more muscles of a person or animal. A first orthotic brace is attachable to a first body part such as a leg or forearm and a fastening mechanism secures this brace to the body part. A second orthotic brace can be mounted on a second body part attached to the first body part. A brace connector pivotally connects the two braces and a linear actuator has an actuator rod mounted for movement into and out of the actuator body. A mounting device is attached to the actuator body for securing the actuator to the first brace. A holder connects the second orthotic brace to the actuator rod. A programmed controller can activate and control the actuator using a power supply such as an air pump. The controller operates the actuator in a repeating cyclical manner.

### REFERENCE TO RELATED APPLICATION

This application claims priority to U.S. Provisional Patent Application Ser. No. 61/898,629, filed Nov. 1, 2013, the entire content of which is incorporated herein by reference.

### FIELD OF THE INVENTION

This invention relates to therapeutic apparatus for exercising muscles such as contracted, hypertonic muscles in persons afflicted with a nervous system injury.

### BACKGROUND OF THE INVENTION

Joint contractures are common in the stroke (CVA, or cerebral vascular accident) and spinal cord injured populations. Those most prone to contracture were those who show no signs of early functional recover (within 2-4 weeks of CVA). Adaptive shortening of tissues around the joints such as the wrist/hand or ankle/foot is seen to occur in week 4, post CVA (see Pandyan et al., Clin Rehab 2003 17:89-95).

The need to stretch a muscle for six hours has been suggested in the literature (Tardieu et al., 1998) and has been discussed by Richardson (2002). Harvey and Herbert (2002) cite studies that found when the soleus muscles of mice were immobilized at short lengths, deleterious length adaptations such as decreases in sarcomere number and muscle resting length could be partly prevented by interrupting immobilization with as little as 15 minutes of stretch each day. Thirty minutes of stretch was enough to completely prevent these changes.

In clinical practice it may not be possible to provide the on-to-one treatment for extended periods of time in either the hospital or home setting because of budget constraints, so casting, splinting and other modalities are used in the management of such patients. There currently is no modality other than manual therapy that creates gains in range of motion and reduction in swelling in the post CVA and spinal cord injured hand and foot.

U.S. published application 2012/0289870 dated Nov. 15, 2012 describes a portable, fluid powered ankle foot orthosis which includes a lower leg mount and a foot bed which are pivotally coupled at the location of the ankle. The apparatus includes a fluid powered rotary actuator receiving power from a wearable fluid power source and providing controlled force and resistance to aid or inhibit relative rotation of the foot bed and a lower leg mount. There is a controller for providing on the basis of data received from sensors control of the rotator actuator to assist the gate of the user.

U.S. Pat. No. 7,578,799 entitled Intelligent Orthosis describes an apparatus comprising an orthotic frame with proximal and distal frame members joined by a knee joint, and foot support joined by an ankle joint to a distal end of the distal frame. The proximal frame is adapted for fitting to a user's upper leg while the distal frame is adapted for fitting to the user's lower leg. The described orthosis has an ankle actuator coupled between the distal frame and the foot support and a knee actuator configured to control flexion of the knee joint according to a variable resistance.

There is a need for an improved, easy to use therapeutic apparatus that is capable of providing periodic stretches to contracted tissues in a disabled part of a body such as tissues in the foot and ankle complex. Further, there is a need for therapeutic apparatus that can promote and maintain functional flexibility in adversely affected areas of a body in order to facilitate possible and eventual motor functional restoration.

### SUMMARY OF THE DESCRIPTION

According to one embodiment of the present disclosure, a therapeutic apparatus for periodic isotonic stretching of one or more muscles of a person or animal includes a first orthotic brace attachable to a first body part and a fastening mechanism for securing this brace to the first body part. The apparatus also has a second orthotic brace for mounting on a second body part attached to the first body part and a brace connector for pivotally connecting the second orthotic brace to one end of the first brace. A linear actuator having an actuator body and an actuator rod mounted for movement into and out of the actuator body is provided together with a mounting device attached to the actuator body for securing the actuator to the first brace. The apparatus also has a holder for connecting the second brace to the actuator rod and a power supply for operating the actuator in order to move the rod in at least one direction. A controller is also provided for activating and controlling the actuator using the power supply, this controller in use operating the actuator in a repeating cyclical manner.

In an exemplary version of this apparatus, the linear actuator is a pneumatic actuator and the power supply is an air pump.

According to another embodiment of this disclosure, a therapeutic apparatus for periodic isotonic stretching of one or more muscles is provided and this apparatus is adapted for use with an orthotic brace assembly. The apparatus comprises a linear actuator having an actuator body and an actuator rod movable into and out of the actuator body and a mounting device attached to the body for securing the actuator to a first section of the brace assembly. There is also a power supply for operating the actuator in order to move the rod in at least one direction and a pivot connector for joining a second section of the orthotic brace assembly to the rod, this connector enabling pivotal movement between the second section and the first section of the brace assembly. A controller is also provided for activating and controlling the actuator using the power supply, this controller in use operating the actuator in a repeating cyclical manner.

In one exemplary version of this apparatus the brace assembly comprises an ankle-foot orthosis wherein the first section of the brace assembly is adapted for mounting on a lower leg portion of a person and the second section is adapted for mounting on a foot of a person. These first and second sections are pivotally connected to one another.

According to a further embodiment of this disclosure, a therapeutic system for periodic isotonic stretching of one or more muscles of a person or animal includes a first orthotic brace adapted for attachment to a first body part and a second orthotic brace adapted for attachment to a second body part joined to the first body part by a body joint. The system further includes a brace connector for pivotally connecting together the first and second orthotic braces and an actuator having an actuator body and an actuator member mounted for movement relative to the actuator body. A mounting device attached to the actuator body is provided for attaching the actuator to the first brace and there are means for connecting the second brace to the actuator member so that during use of the system, movement of the actuator member can move the second brace and the second body part in a desired manner. A power supply device is provided to operate the actuator in order to move the actuator member in a predetermined direction and a programmed controller can activate and control the actuator using the power supply device. The controller in use operates the actuator in a repeating cyclical manner.

In one exemplary version of this system, the controller is an on board microprocessor having an electronic control circuit and a potentiometer used to set an amount of ON time for operation of the power supply device.

Further features and advantages will become apparent from the following detailed description taken in conjunction with the accompanying drawings.

### BRIEF DESCRIPTION OF THE DRAWINGS

FIG. 1 is a side view of a first embodiment of a therapeutic apparatus shown mounted on a person's leg and shown engaging a foot in a first position;

FIG. 2 is a side view similar to FIG. 1 but showing the foot pulled by the apparatus to a second position;

FIG. 3 is a perspective view of the therapeutic apparatus of FIG. 1 as seen from the closed end of the actuator and showing the top of the shoe worn on the foot;

FIG. 4 is an exploded view of main components of the therapeutic apparatus of FIGS. 1 to 3;

FIG. 5 is a perspective view taken from above of another embodiment of therapeutic apparatus with a portion of one brace shown separated for sake of illustration;

FIG. 6 is another perspective view of the therapeutic apparatus of FIG. 5, this view being taken from below;

FIG. 7 is a block diagram illustrating the operational steps in the software program for the controller; and

FIG. 8 is an electronic circuit diagram for the controller and showing the pump connected to the controller.

### DETAILED DESCRIPTION OF THE INVENTION

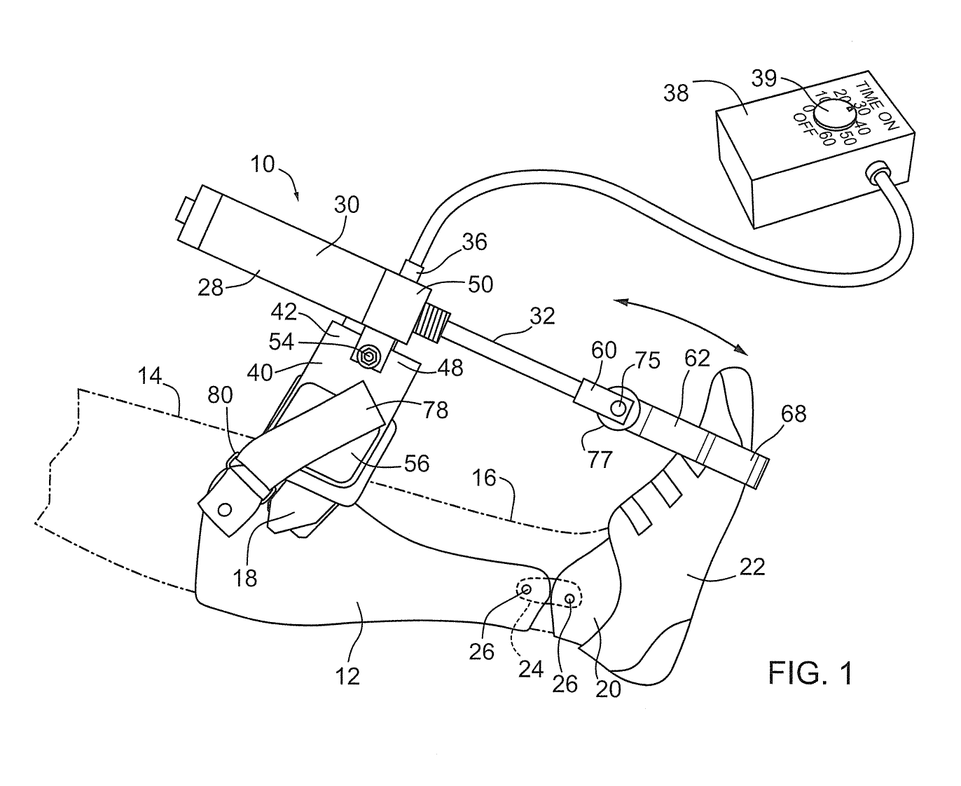

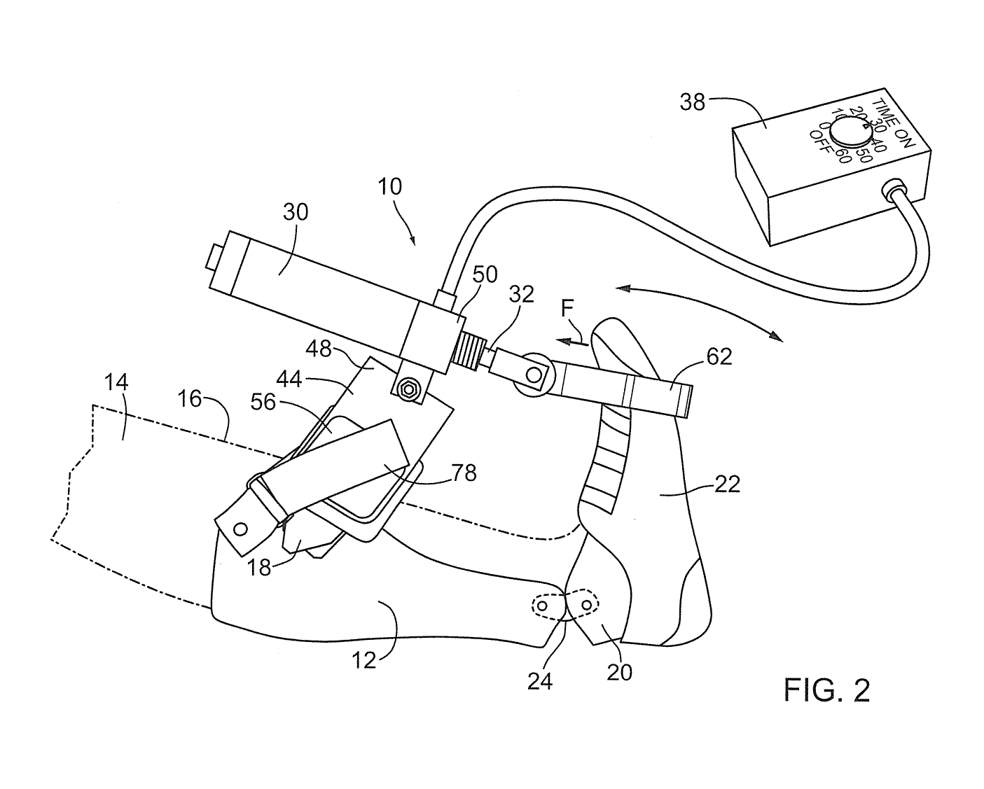

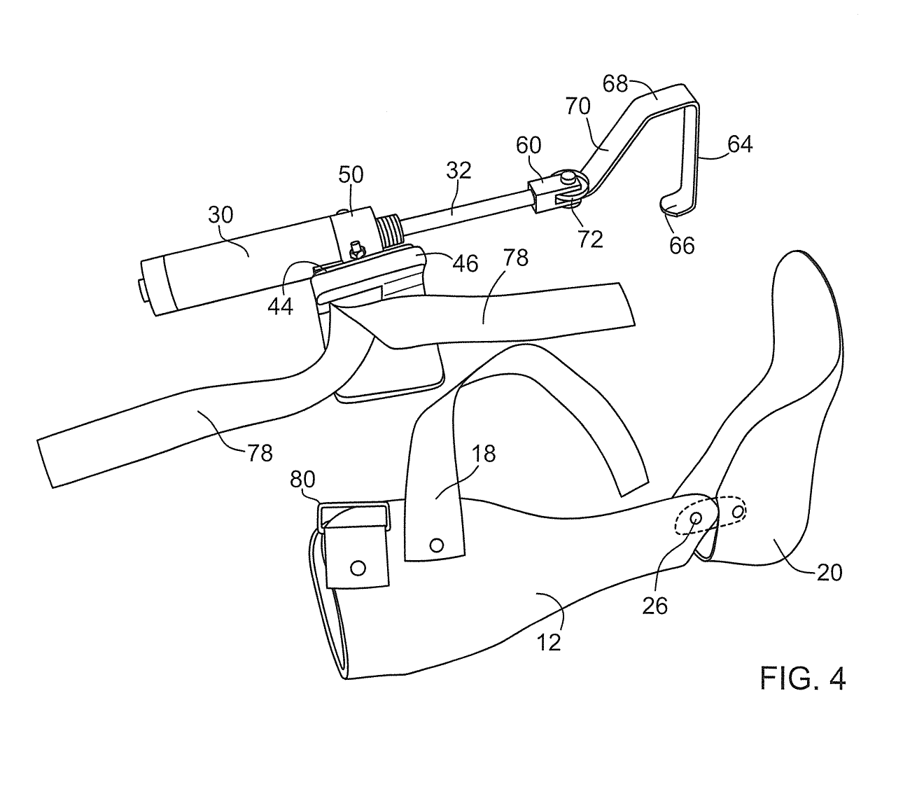

FIGS. 1 to 3 illustrate a first embodiment of a therapeutic apparatus 10 for periodic isotonic stretching of the muscles of a person and, in particular and as illustrated in these figures, for stretching the muscles in the foot of a person. It will be understood that although the embodiments described herein are shown and described mounted on human body parts such as the leg and the arm, variations of the therapeutic apparatus can also be made for use on animals. The first version 10 includes a first orthotic brace 12 attachable to a first body part which as illustrated can be the lower portion of the person's leg including the shin area. The leg 14 and shin 16 are outlined in dot-dash lines. A fastening mechanism 18 is provided for securing the first orthotic brace 12 to the first body part, in this case the lower portion of the leg 14. This fastening mechanism can comprise a flexible strap of known construction that is attached at one side of the top of the brace and extends across the leg to the opposite side of the brace where it can be secured by a buckle or alternatively by a hook and loop fastener arrangement (commonly sold under the trademark VELCRO). The apparatus can also include a second orthotic brace 20, only a portion of which is visible in FIGS. 1 to 3 as it extends into a suitable shoe 22 worn around the foot. The second brace 20 can be seen clearly in the exploded view of FIG. 4. A brace connector 24 pivotally connects the second orthotic brace to the adjacent end of the first orthotic brace 12. In one exemplary embodiment this connector comprises two hinges, one on each side of the brace assembly and these hinges can be in the form of living hinges made of plastic with the ends of each hinge attached to the adjacent brace or brace section by rivets 26. It will be understood that the illustrated first and second braces can also be described as first and second sections of an orthotic brace assembly. The first and second braces can be standard components of a known ankle-foot orthosis (AFO) which is an orthosis or brace (usually plastic) that supports the ankle and foot. AFOs are known for and have been used previously to control the position and motion of an ankle, to compensate for weakness, or to correct deformities. These standard braces have been used to support weak limbs, or to position a limb with contracted muscles into a more normal position.

The apparatus 10 further includes a linear actuator 28 which has an actuator body in the form of an actuator cylinder 30 and an actuator rod 32 mounted for movement into and out of the actuator body. A clevis 60 can be mounted on the outer end of the rod as shown for attachment purposes described hereinafter. A mounting device is provided to attach the actuator cylinder 30 to the first orthotic brace 12 and as a consequence also to the lower portion of the leg. This mounting device 40 includes a shin pad assembly 42 which includes a shin pad member having a Y configuration in an end view. The shin pad assembly includes plastic strut 44 having a central connecting section 48 and two diverging legs 49 which can have a generally square shape. On the inner side of the two legs 49 can be provided foam padding 46 so that the shin pad member can rest comfortably on the person's shin 16. It is also possible for this shin pad member to rest on a front portion of the first brace or the strap connector at the top of this brace. The central section 48 can be provided with a single attachment hole 51 for attaching the shin pad member to a cylinder clamp 50 which extends around the actuator cylinder adjacent the rod end thereof. A machine screw 54 extends through holes in connecting tabs 52 and through hole 51 to connect the shin pad member. Also the exemplary embodiment of the shin pad member has a fastening pad 56 attached to the exterior of each of the diverging legs 49, the purpose of which is explained below. The pad 56 can be part of a hook and loop fastener, for example the pad can be covered with numerous small hooks that readily connect to a pad or strip covered with small loops.

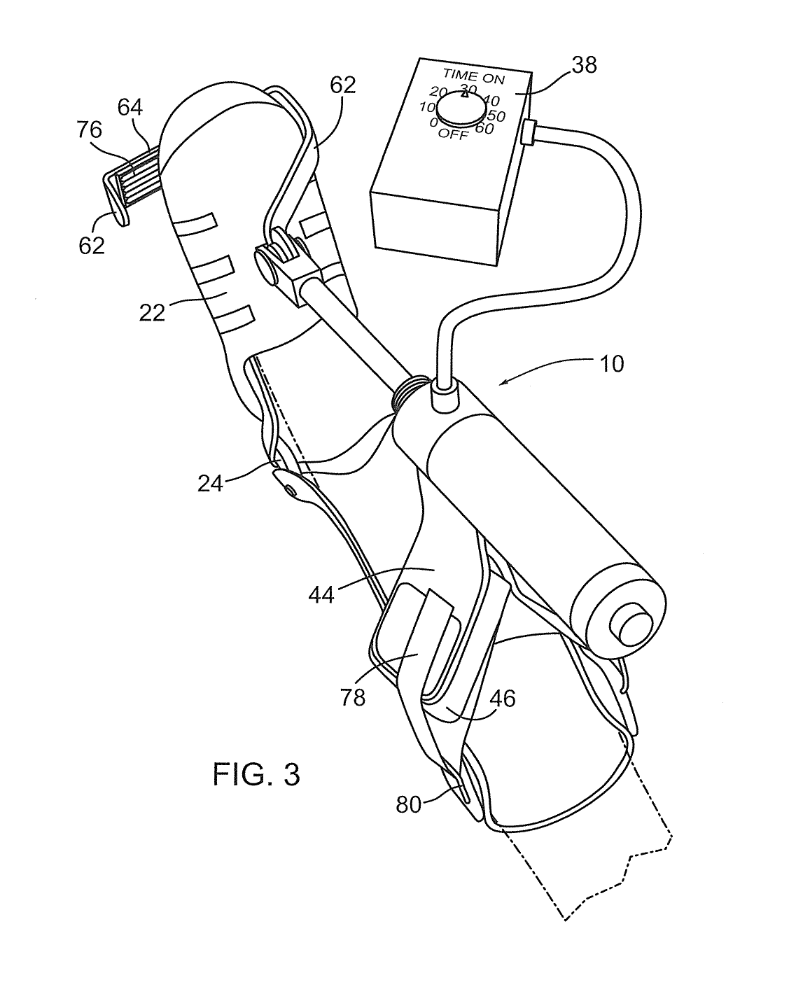

The therapeutic apparatus 10 includes a holder for connecting the second brace 20 to the end of the actuator rod. In an illustrated embodiment this holder includes a stirrup 62 adapted to extend under both the shoe 22 worn on the person's foot and the second orthotic brace arranged in the shoe. The stirrup, which is best seen in FIG. 4, has a straight bottom section 64 that is long enough to extend across the bottom of the shoe and that can end with a flange 66 to help hold the shoe in the stirrup. A short connecting section 68 can extend upwardly from the bottom section. A sloping section 70 of the stirrup extends to a vertical end flange 72. The end flange has a hole 73 through which a threaded fastener 75 extends to connect the stirrup to the clevis 60. An exemplary form of the stirrup can be made of formed aluminum bar. In the version of the apparatus 10 shown in FIGS. 1 to 3, when the linear actuator is pressurized, the stirrup 62 is pulled by the rod to apply a predetermined force to the affected body part and its muscles. This operation is done in a repeating cyclical manner for a selected period of time, thereby providing slow, repeated isotonic stretches to the muscles, which may be affected by contracture and/or spasticity. If desired, a corrugated rubber gripping pad 76 can be affixed to the bottom section of the stirrup (as shown in FIG. 3). This pad helps prevent the front end of the shoe from slipping out of the stirrup.

Also shown in FIGS. 1 to 4 is a pair of flexible, strong straps 78. At one end, each of these straps can be secured to the inside of the plastic strut 44, as shown in FIG. 4. In one version, the ends are clamped in the connecting section 48. Each strap extends through a metal buckle 80 mounted on a respective one of the two sides of the orthotic brace 12. After passing through the buckle, the projecting section of the strap is secured by another part (for example, the loop part) of a hook and loop type fastener to its respective fastener pad 56. It will be understood that one part of the hook and loop type fastener is secured to and extends along the side of the strap 78 facing the pad 56. In this way, the shin pad assembly is securely connected to the orthotic brace 12 and the shin pad member engages and presses against the shin of the person, as shown in FIGS. 1 to 3.

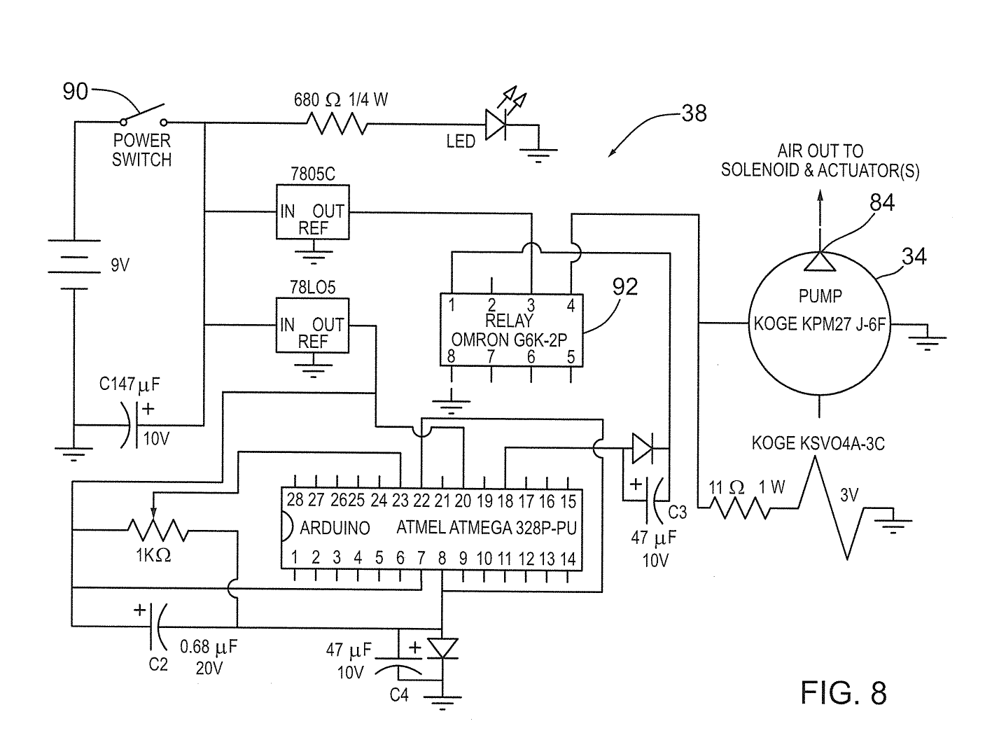

The therapeutic apparatus further includes a power supply for operating the linear actuator in order to move the rod 32 in at least one direction. An exemplary power supply in the form of an air pump 34 is illustrated schematically in FIG. 8. One exemplary pneumatic pump is a triple diaphragm rotary pneumatic pump operating on six volts DC such as Koge Model KPM27 J-6F capable of providing pressure between 0-12 psig. The pump 34 has an air outlet that can provide the pressurized air to a pneumatic solenoid and the actuator. The solenoid can be a two port, two position solenoid, normally passing three volts. One suitable solenoid is a Koge Model KSV04A-3C. The pump 34 is engaged during the “stretch time” provided by the controller and it is turned off during the rest time. The venting of air in the pneumatic system is created by the normally passing solenoid ventilation valve. During the “stretch time” the valve is energized which seals the pneumatic system allowing pressure to develop which, in the version of the apparatus illustrated in FIGS. 1 to 3, causes retraction of the rod of the actuator. During the “rest time” the solenoid valve de-energizes and goes to a passing state wherein the pressurized air in the system is vented through the valve, thereby allowing the rod to extend under the forces applied by the foot muscles.

### Controller

The controller 38 will now be described with particular reference to the circuit diagram of FIG. 8. The purpose of the controller 38 is to activate and control the linear actuator 28 using the power supply, such as the air pump. Controller 38 in use operates the linear actuator in a repeating cyclical manner for a selected period of time. The control software is on board the controller which includes a microprocessor such as Arduino UNO (Atmel ATMEGA328P-PU). The controller monitors the setting on a potentiometer which can be a 1000 OHM linear unit and it changes the timing control parameters based on the potentiometer's position. There are two time settings in the program software, one of these settings being adjustable by the user and the other time normally being set by pre-programmed parameters in the software. A so-called “stretch time” is adjustable by the user through a rotatable dial 39 on the front of the controller 38. In one exemplary version of the controller, the minimum stretch time is 10 seconds and the maximum stretch time is 60 seconds. During the stretch time the pump is active and the ventilation solenoid is closed to atmosphere. Air is delivered to the cylinder of the actuator and a stretching force is applied to the body part (in the version shown in FIGS. 1 to 3, the apparatus stretches the foot muscles by pulling upwardly on the front portion of the foot). Normally the rest time is not adjustable by the user and this value is generally preset in the software to twenty seconds although this amount of time can vary depending upon the particular therapy and the muscles being exercised. During the rest time, the pump 34 is turned off and the ventilation solenoid is turned off so that it allows the air in the pneumatic cylinder to vent to atmosphere. In this state, the actuator illustrated in FIGS. 1 to 3 is set up so that the rod extends from the cylinder due to the forces applied by the muscles in the foot.

The electrical components which make up the control circuit are identified in FIG. 8, these components including a power switch at 90 to turn the controller on or off and a power adaptor comprising a nine volt switching steady state transformer in one exemplary embodiment (2.1 mm port center positive). The circuit further includes a relay 92 which can be a DPDT 5 volt coil low current relay such as an Omron G6K-2P. The controller 38 can provide a cycled time during which the on time and off time repeat each other continuously. The cycled time is the amount of time the controller is running both the on time and off time. In other words, this is the amount of time that the controller is actively engaging the actuator of the apparatus 10. In an exemplary form of use of the present therapeutic apparatus the cycled time is set internally and is not adjustable by the end user. The cycled time will start when the controller is turned on. The end of the cycled time or the length of the cycled time is set internally before the controller is dispensed to an end user. The length of the cycled time can vary depending on the user's rehabilitation requirements.

There are two types of cycled time settings, with the first being the “length time” which is based on length of time the controller is engaging the pneumatic actuator. The second is the “rep time” and is based on the number of on time-off time cycles. The length time can vary from one half hour to several hours and during this time the controller will continuously actuate and disengage the actuator for as long as the length time is set. Once this type of cycle time has expired, the controller will stop engaging the actuator.

In the case of the rep time, this can be set to 100 repetitions, for example. Once the controller has counted 100 repetitions of on time, this type of cycle time will end. This type of cycle time is variable and can be set to any number of repetitions. Once this type of cycle time has expired, the controller will stop engaging the pneumatic actuator.

In one exemplary version of the therapeutic apparatus, the cycled time is active in only a set amount of time in one 24 hour period and once this cycled time has ended, the controller will not engage the pneumatic actuator for a period of 24 hours, but the latter period can be adjusted. In an exemplary version of the apparatus, if the user shuts down the controller and turns it on again, it will not engage or reset the cycled time and the user must wait 24 hours from the start of the previous cycled time before a new cycled time begins.

A program for the therapeutic apparatus 10 can be programmed into a microcontroller or microprocessor within the electronic circuit. The microcontroller receives feedback from the single pole, single throw switch 90 as well as the 1000 ohms potentiometer. The program processes the input information and outputs its commands to the relay 92 which drives the pneumatic solenoid valve as well as the pump. The pump and solenoid are connected to the normally open contact on the relay so that when the relay is energized by the microcontroller, the pump and solenoid are engaged.

The following is a software program for one embodiment of the controller:

Processor Software

```
Current Version
// split the delay times into 10ms blocks and added communication code
// ---
// added algorithm to compensate for potentiometer variance
// 1.0
// initial revision
//--------------------------
int potpin1 = A0; // select the input pin for the potentiometer
int relay1 = 12; // select the pin for the load **** USE THIS IF
INSTALLING ON OLD PCB ****
//int relay1 = 9; // select the pin for the load
float pot1 = 0; // variable to store the value coming from the sensor
float oldpot = 0;
int state = 0; //stores if we are on or off
int off = 20000; //time device is off
float on = 0; //
#include “math.h”;
void setup( ) {
  // Serial.begin(9600); // just left here for diagnostics
  // declare the ledPin as an OUTPUT:
  pinMode(relay1, OUTPUT);
}
void loop( ) {
  /* if (pot1 == oldpot)
  {
    true; //if the pot value has not changed, leave it alone - do nothing.
  }
  else
  {
    state = 0; //if the pot value changes, turn off the relay to begin the
    cycle with the new value on = pot1;
  }
  */
  if (state == 0)
  {
    digitalWrite(relay1, LOW); //make sure the relay is off
    delay(10);
    off = off − 10; //remove our wait time from total off time
    on = 0;
    if (off <= 0)
    {
      state = 1; //on next loop, turn on the circuit if we have run out
      of off time
      on = pot1; //set up for turning on the relay
    }
    pot1 = 0;
  }
  if (state == 1)
  {
    if (on > 0)
    {
      digitalWrite(relay1, HIGH);
      delay(10);
      on = on − 10;
      off = 0;
    }
    if (on <= 0)
    {
      state = 0; //if we reach the end of the counter, turn off at the end
      of the loop
      off = 20000; //reset off time
    }
    pot1 = 0;
  }
  // read the value from the sensor:
  oldpot = pot1;
  pot1 = analogRead(potpin1);
  // if input is zero then skim math function and
  if (pot1 > 0)
  {
    //pot1 = (60.0000/1024.0000)*pot1;
    //pot1=pot1*1000;
    pot1 = pot1 * 60/1000; // convert analog input to seconds
    //math function to adjust for inconsistancy in the pot
    pot1 = pot1 + (14*(1/(pow((pot1+2.5),.3)))−3);
    pot1 = pot1 * 1000; // Convert to milli seconds
  }
} // end loop
```

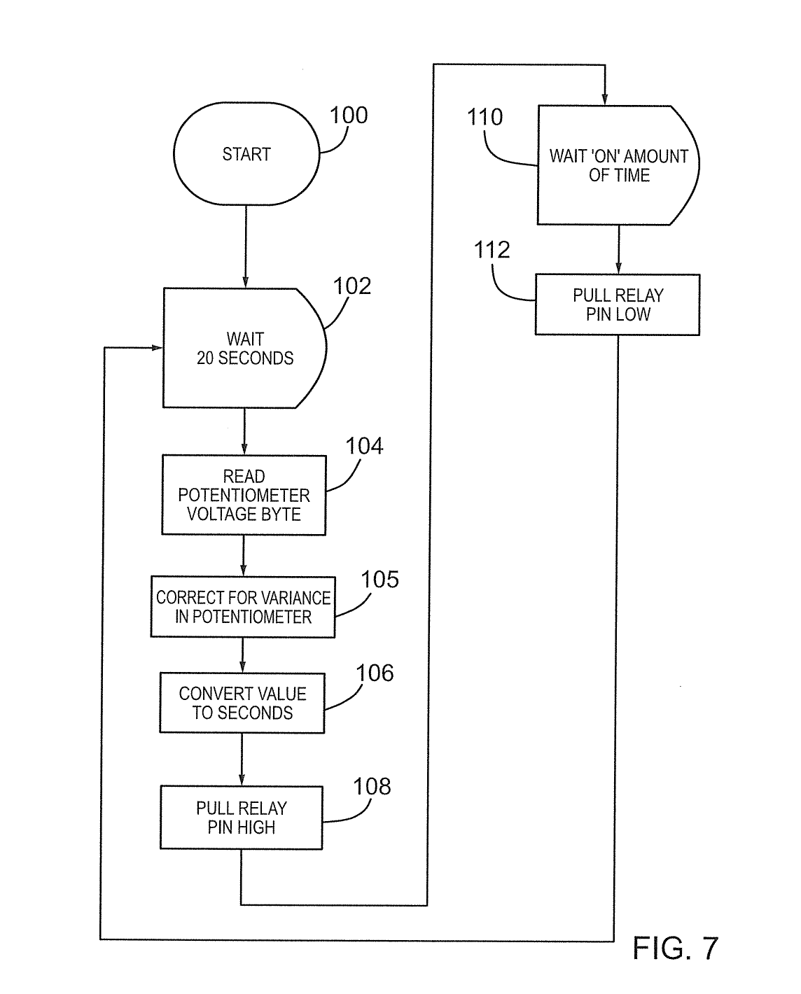

FIG. 7 provides a block diagram illustration of the software program. At the start 100 when the controller is turned on by engaging the power switch 90, there is a 20 second delay at 102 to allow the reader to turn the dial on the controller and set the length of time, which is the stretch time in the cycle. The program then reads the potentiometer which feeds a variable voltage to the control circuit (0-5 volts DC). The greater the voltage, the longer the on time which, in one embodiment, can vary between 0 and 60 seconds. Zero voltage from the potentiometer sets the on time to zero while a 5 volt signal from the potentiometer sets the on time to 60 seconds. The voltage to time ratio has a linear relationship. The voltage from the potentiometer is determined at step 104. At step 105 the program corrects for variance in the potentiometer and at step 106 the program converts the value to seconds. At step 108, the program sends a command to the relay 92 in order to drive both the solenoid valve as well as the pump 34, which are allowed to continue to operate for the “on” amount of time as indicated at 110. The program then goes to the off time position indicated at 112 where the pressurized air in the pneumatic system is vented through the solenoid valve and, in the case of the embodiment shown in FIGS. 1 to 3, the actuator rod is allowed to extend under muscle force from the foot.

### Therapeutic Apparatus for Hand Muscles

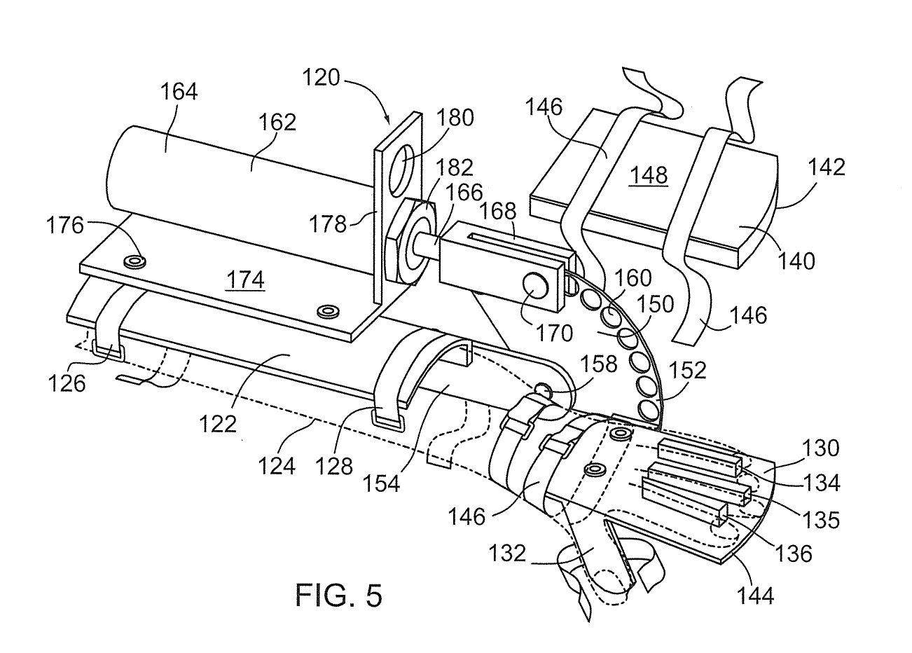

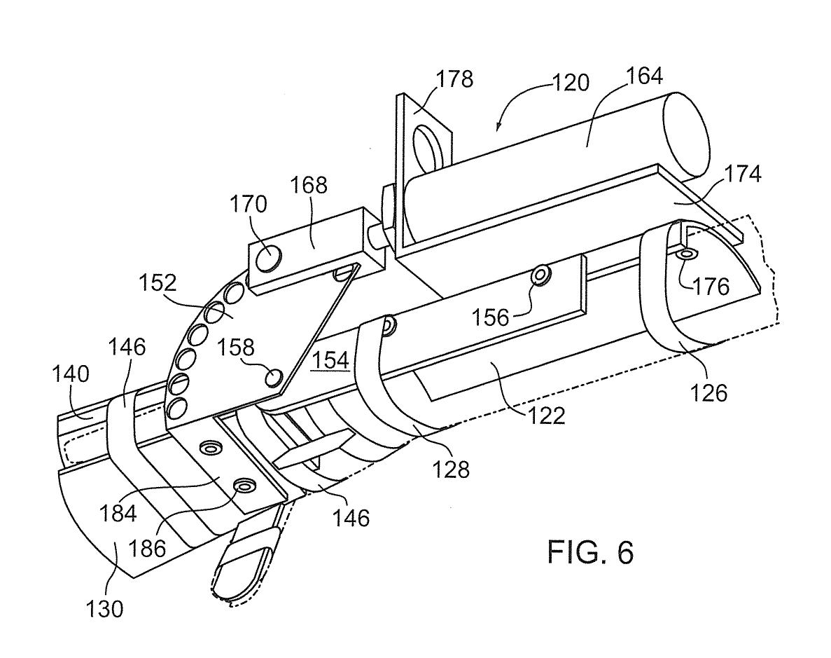

Illustrated in FIGS. 5 and 6 is an alternative form of therapeutic apparatus capable of exercising the muscles in a person's hand in a repeating cycle manner. This therapeutic apparatus 120 includes a first orthotic brace 122 attachable to a first body part such as the forearm of a person, this forearm being indicated by dot-dash lines at 124. There is a fastening mechanism for securing this orthotic brace to the first body part which can include a couple of forearm straps 126, 128 shown in FIG. 6. These straps can be secured in the normal way by buckles or alternatively by Velcro fastener strips and the straps are tightened so as to prevent movement of the brace relative to the forearm. A second orthotic brace 130 for mounting on a second body part attached to the first body part is provided. The second brace 130 can comprise a finger platform having a generally rectangular shape on which four fingers of a hand can be placed or supported. The finger platform can have a thumb extension 132 which can be used to hold the thumb in a desired position. In this position the thumb may extend perpendicular to the four other fingers. The finger platform can include elongate finger dividers 134, 135, 136. There can be mounted on top of the finger platform a further brace section 140 having a similar size and shape as the finger platform. The brace section 140 can be a dorsal finger slab which can be thicker than the finger platform 130 in order to resist bending forces by the fingers. If desired, both the finger platform and the brace section 140 can have curved outer edges indicated at 142 and 144. Two finger straps 146 can be looped around the top surface 148 of the brace section and the bottom surface of the finger platform in order to clamp the four fingers between these two brace members and hold the fingers straight as shown.

The apparatus 120 further includes a brace connector for pivotally connecting the second orthotic brace 130 to one end of the first orthotic brace 122. This brace connector 150 can comprise an actuator connecting plate 152 and a straight hinge arm 154, the latter being connected by two rivets 156 to the brace 122. The connecting plate 152 is pivotably connected to the arm 154 by a pivot pin at 158. An exemplary form of the connecting plate is sector shaped as shown and extending along the curved edge of this plate are a series of connecting holes 160 which allow for the adjustment of the position where the rod of the linear actuator 162 is connected to the edge of the plate. The linear actuator can be similar in its construction to the above described actuator 28 of the first embodiment.

The linear actuator 162 has an actuator body 164 in the form of a cylinder which can be a pneumatic cylinder. An actuator rod 166 is mounted for movement into and out of the actuator body. Mounted at the other end of this rod is a clevis 168. The clevis can be pivotally attached to the plate 152 by means of a pivot pin 170 which extends through a selected one of the holes 160. The holes selected will depend upon the motion through which the hand is to be moved by the actuator and this motion can vary as treatment progresses. The actuator cylinder is rigidly attached to the first brace 122 by means of a mounting bracket 174. One elongate leg of this bracket can be attached to the main, curved portion of the brace by means of two rivets 176. The rod end of the actuator cylinder is attached to a further leg 178 of the bracket. If desired, this leg can be formed with two cylinder attachment holes 180 to allow for adjustment in the position of the end of the cylinder. The cylinder can be attached to this bracket at the rod end by means of a nut 182 which is threaded onto an end projection formed on the cylinder that extends around the rod opening.

The manner by which the connecting plate 152 is connected to the second orthotic brace 130 is shown in FIG. 6. Extending from an outer corner of the plate is a rigid connecting strap 184 which can be attached by rivets 186 to the finger slab or brace 130.

It will be understood that the actuator cylinder of this therapeutic apparatus is connected to an air pump and a controller in the same manner as the therapeutic apparatus 10. The pump can be turned on by the controller in order to pressurize the cylinder in a manner which retracts the rod 166 causing the hand to be pulled upwardly to the position shown in FIG. 5. When the pump is turned off by the controller, the muscles in the hand can on their own pull the actuator rod out of the cylinder during this rest phase. The cycle of stretch time and rest time repeats itself for the number of cycles programmed into the controller. As therapy of the hand muscles progresses over a period of time, the attachment point of the clevis of the actuator to the brace connector 150 can be changed in order to move the hand and fingers through a different range or by a larger amount.

Although the present invention has been illustrated and described in exemplary embodiments, e.g., embodiments having particular utility in exercising muscles in a person's foot or in a person's hand, it is to be understood that the present invention is not limited to the details shown herein, since it will be understood that the various omissions, modifications, substitutions and changes in the forms and details of the disclosed apparatus and system and their operation may be made by those skilled in the art without departing in any way from the scope of the present invention. Those of ordinary skill in the art will readily adapt the present disclosure for various other applications without departing from the scope of the present invention.

1. A therapeutic apparatus for periodic isotonic stretching of one or more muscles of a person or animal, said apparatus comprising:
a first orthotic brace attachable to a first body part;
a fastening mechanism for securing said first orthotic brace to said first body part;
a second orthotic brace for mounting on a second body part attached to said first body part;
a brace connector for pivotally connecting said second orthotic brace to one end of the first orthotic brace;
a linear actuator having an actuator body and an actuator rod mounted for movement into and out of said actuator body;
a mounting device attached to said actuator body for securing said linear actuator to said first orthotic brace;
a holder for connecting said second orthotic brace to said actuator rod;
a power supply for operating said linear actuator in order to move said rod in at least one direction; and
a controller for activating and controlling the linear actuator using said power supply, said controller in use operating the linear actuator in a repeating cyclical manner.

2. A therapeutic apparatus according to claim 1 wherein said linear actuator is a pneumatic actuator and said power supply is an air pump.

3. A therapeutic apparatus according to claim 1 wherein said first and second orthotic braces comprise an ankle-foot orthosis.

4. A therapeutic apparatus according to claim 1 wherein said first orthotic brace is adapted for mounting on a person's forearm and said second orthotic brace is adapted for mounting on a person's hand.

5. A therapeutic apparatus according to claim 1 wherein said fastening mechanism is a connecting strap secured at one end thereof to said first orthotic brace.

6. A therapeutic apparatus according to claim 1 wherein said mounting device is a shin pad assembly including a shin pad member adapted to engage the shin of a person and an anchoring strap arrangement attached to the shin pad member for attaching the shin pad member to the first orthotic brace.

7. A therapeutic apparatus according to claim 1 wherein said second body part is a foot, said holder is a stirrup adapted to extend under both a shoe worn on said foot and the second orthotic brace.

8. A therapeutic apparatus according to claim 4 wherein said mounting device is a metal support bracket fastened both to an outer side of the first orthotic brace and to the actuator body.

9. A therapeutic apparatus according to claim 1 wherein said controller includes a micro controller, a relay operated by said micro controller and a pneumatic solenoid valve driven by said relay.

10. A therapeutic apparatus according to claim 6 wherein said anchoring strap includes one part of a hook and loop type fastener and a second part of the hook and loop type fastener is secured to an outer surface of the shin pad member, said first and second parts being adapted to securely connect to each other.

11. A therapeutic apparatus for periodic isotonic stretching of one or more muscles, said apparatus adapted for use with an orthotic brace assembly and comprising:
a linear actuator having an actuator body and an actuator rod movable into and out of said actuator body;
a mounting device attached to said actuator body for securing said linear actuator to a first section of an orthotic brace assembly;
a power supply for operating said linear actuator in order to move said rod in at least one direction;
a pivot connector for joining a second section of the orthotic brace assembly to said actuator rod, said connector enabling relative pivotal movement between said second section and said first section of the orthotic brace assembly; and
a controller for activating and controlling said linear actuator using said power supply, said controller in use operating said linear actuator in a repeating cyclical manner.

12. A therapeutic apparatus according to claim 11 wherein said linear actuator is a pneumatic actuator and said power supply is an air pump.

13. A therapeutic apparatus according to claim 11 including said orthotic brace assembly which comprises an ankle-foot orthosis, wherein said first section of the orthotic brace assembly is adapted for mounting on a lower leg portion of a person, said second section of the orthotic brace is adapted for mounting on a foot of a person, and said first and second sections are pivotally connected to one another.

14. A therapeutic apparatus according to claim 11 including said orthotic brace assembly, which comprises a forearm cuff adapted for mounting on a forearm of a person and a finger platform-type brace adapted for bracing the person's fingers, wherein said pivot connector includes a connecting plate having an arcuate edge, a pivot pin connection spaced from said arcuate edge and a hinge arm having one end pivotally connected to said connecting plate at said pivot pin connection, said actuator rod being pivotally connected to said connecting plate adjacent said arcuate edge.

15. A therapeutic apparatus according to claim 11 wherein said mounting device is a shin pad assembly including a shin pad member adapted to engage the shin of a person and an anchoring strap arrangement attached to the shin pad member for attaching the shin pad member to the first section of the orthotic brace assembly.

16. A therapeutic system for periodic isotonic stretching of one or more muscles of a person or animal, said system comprising:
a first orthotic brace adapted for attachment to a first body part of the person or animal;
a second orthotic brace adapted for attachment to a second body part joined to said first body part by a body joint;
a brace connector for pivotally connecting together said first and second orthotic braces;
an actuator having an actuator body and an actuator member mounted for movement relative to said actuator body;
a mounting device attached to said actuator body for attaching said actuator to said first orthotic brace;
means for connecting said second orthotic brace to said actuator member so that during use of the system, movement of said actuator member can move the second orthotic brace and the second body part in a desired manner;
power supply means for operating said actuator in order to move said actuator member in a predetermined direction; and
a programmed controller for activating and controlling said actuator using said power supply means, said controller in use operating said actuator in a repeating cyclical manner.

17. A therapeutic system according to claim 16 wherein said actuator is a pneumatic linear actuator, said actuator member is an actuator rod mounted for movement into and out of said actuator body, and said power supply means is an air pump.

18. A therapeutic system according to claim 16 wherein said controller is an on board microprocessor having an electronic control circuit and a potentiometer used to set an amount of ON time for operation of said power supply means.

19. A therapeutic system according to claim 17 wherein said controller has an on board microprocessor and a pneumatic ventilation solenoid which closes from atmosphere a pneumatic system for inflating said actuator and moving said actuator rod in said predetermined direction and which vents air from said actuator body during deflation and movement of said actuator rod in an opposite direction.

20. A therapeutic system according to claim 16 wherein said controller controls movement of said second orthotic brace whereby during use of the system the one or more muscles are stretched for a first selected period of time chosen by a user of the system, subsequently said one or more muscles are permitted to return to an unstretched state for a second period of time, and then the cycle of stretching for the first period of time and returning to an unstretched state for the second period of time is repeated.
